(19) United States
(12) Patent Application Publication
(10) Pub. No.: US 2003/0062833 A1
(43) Pub. Date: Apr. 3, 2003

(54) Mini-type decorative bulb capable of emitting light through entire circumferential face

(76) Inventor: Wen-Yen Tai, Hsinchu (TW)

Correspondence Address: DOUGHERTY & TROXELL, 5205 LEESBURG PIKE, SUITE 1404, FALLS CHURCH, VA, 22041, US

(21) Appl. No.: 09/968,863

(22) Filed: Oct. 3, 2001

(51) Int. Cl. H01K 1/50

(52) U.S. Cl. 313/578

(57) ABSTRACT

Mini-type decorative bulb capable of emitting light through entire circumferential face, including a main body made of blank glass tube. A bead is disposed in the main body for locating two conductive wires. The conductive wires partially extend out of the main body for connecting with a power source. Inner sections of the conductive wires extend into the main body for connecting with tungsten filaments. When a wick composed of the bead, the conductive wires and the tungsten filaments is magnetically attracted and located in the main body, top end of the glass main body is blown and rounded to form a dome face through which light can pass. The other end of the main body is clamped and closed to form a flat end which can be easily plugged into a bulb seat.

### BACKGROUND OF THE INVENTION

The present invention is related to a mini-type decorative bulb capable of emitting light through entire circumferential face. The mini-type decorative bulb is applicable to Christmas light string.

A conventional Christmas light string is formed of a number of mini-type bulbs serially connected by the same wire. Such mini-type bulbs are generally mass-produced in factory at low cost.

FIG. 1 shows the low price mini-type bulb which has a vacuumized glass main body 10. A bead 11 is disposed in the main body 10 for locating two conductive wires 12, 13. One end of the conductive wires 12, 13 outward protrudes from the main body 10 for connecting with a power source. The other end of the conductive wires is connected with a tungsten filament 14 and a secure fuse inside the main body 10.

FIG. 2 shows the final molding stage of the mini-type decorative bulb when automatically mass-produced in factory. The blank glass tube 100 for the main body 10 is vacuumized and heated and softened at preset position A. The softened portion is outward pulled and converged to form a sintered dome 15 as shown in FIG. 1. When the tungsten filament 14 is powered on to emit light, the sintered dome 15 which is a solid block of glass material is nearly totally opaque. Therefore, the light can only pass through the circumferential face of the bulb main body 10, while failing to pass through the dome 15. Accordingly, the light emitting effect is limited.

With respect to the currently popular so-called double-color bulb, two separate tungsten filaments are connected with the internal conductive wire of the bulb. The two tungsten filaments emit light in different color sections so that one bulb can emit two different colors of light. However, the light still can hardly pass through the dome of such mini-type decorative bulb so that the light emitting and decorative effect is still affected.

With respect to those mini-type bulb used in some meters, greater density of light is required. Therefore, the glass main body directly attaches to the bead and encloses the same so as to eliminate the dome which is the dead corner of light. However, such bulb must be made of lead-containing blank glass tube. The cost for such material is too high so that it is not suitable for the conventional mini-type decorative bulb manufactured at low cost.

### SUMMARY OF THE INVENTION

It is therefore a primary object of the present invention to provide a mini-type decorative bulb capable of emitting light through entire circumferential face. The bulb is mass-produced from general blank glass tube at low cost. When a wick composed of the bead, the conductive wires and the tungsten filaments is magnetically attracted and located in the main body, top end of the glass main body is blown and rounded to form a dome face through which light can pass. The other end of the main body is then sintered to form a flat tail end.

The present invention can be best understood through the following description and accompanying drawings wherein:

### BRIEF DESCRIPTION OF THE DRAWINGS

FIG. 1 is a perspective view of a conventional mini-type decorative bulb;

FIG. 2 is a perspective view according to FIG. 1, showing the final stage of forming of the bulb;

FIG. 3 is a perspective view of the mini-type decorative bulb of the present invention;

FIG. 4 is a side view according to FIG. 3;

FIG. 5 shows the manufacturing procedure of the present invention; and

FIG. 6 is a perspective view of another embodiment of the present invention.

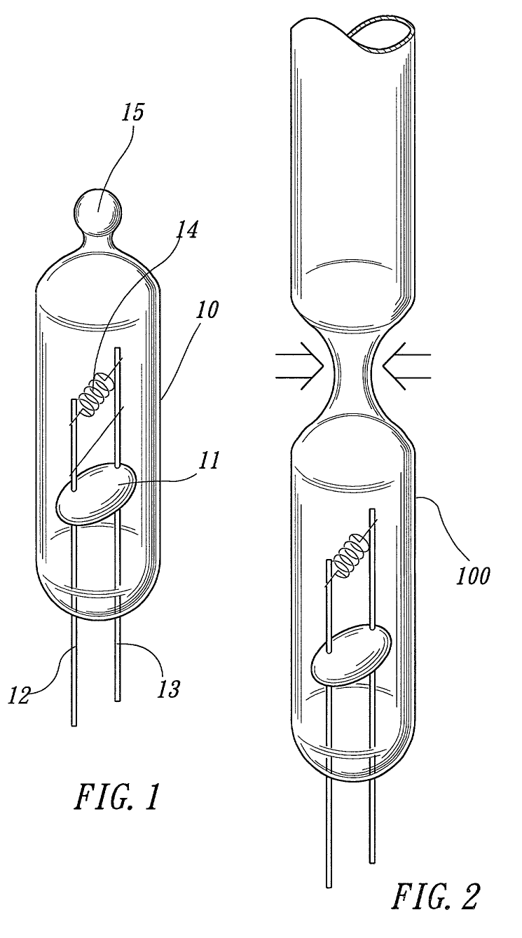

### DETAILED DESCRIPTION OF THE PREFERRED EMBODIMENTS

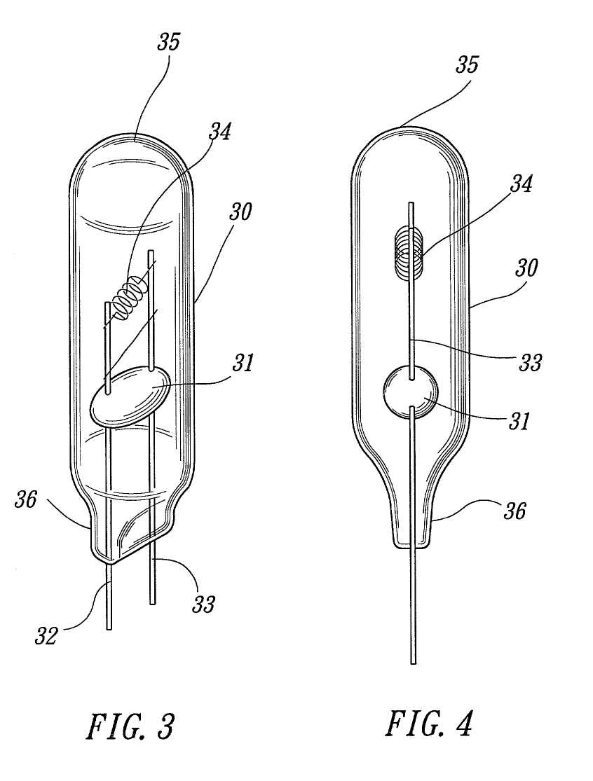

Please refer to FIGS. 3 and 4. The mini-type decorative bulb of the present invention has a main body 30 made of general blank glass tube. A bead 31 is disposed in the main body 30 for locating two conductive wires 32, 33. At least one tungsten filament 34 is connected between the ends of the conductive wires 32, 33 extending into the main body 30.

A wick composed of the bead 31, conductive wires 32, 33 and the tungsten filament 34 is disposed in the glass main body 30. When magnetically attracted and located, the wick permits one end of the blank tube to be blown into a dome top end 35 and the bottom end is formed with a flat close end 36.

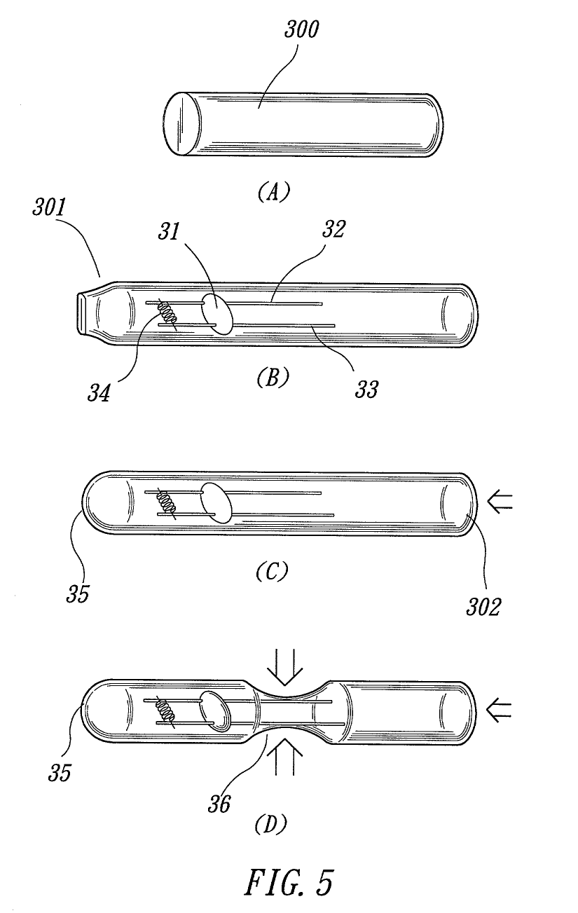

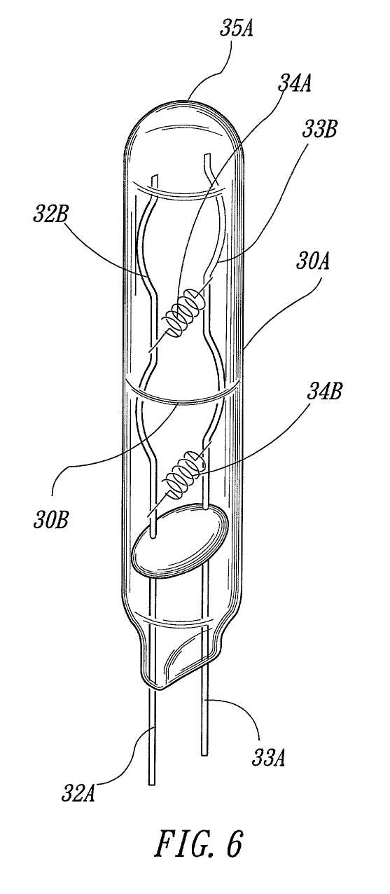

There are many measures for forming the above mini-type decorative bulb. FIG. 5 shows a preferred manufacturing flow chart. In step B, the wick is blown into the blank glass tube 300. Thereafter, one end 301 of the glass tube is previously clamped and sealed. In step C, the wick is magnetically attracted and located and then the clamped end 301 is blown and rounded. The blowing air is conducted into the glass tube from the other open end 302. Finally, in step D, the glass tube is heated, pulled, extended and clamped to form the flat close end 36.

Accordingly, a mini-type decorative bulb with dome top face 35 is achieved. Therefore, the limitation of the mini-type decorative bulb in light emitting effect is overcome. Moreover, the flat close end 36 can be more stably and suitably located in a corresponding bulb seat (not shown).

The present invention is more applicable to the double-color bulb with two tungsten filaments. The bulb 30A is divided by a color dividing line 30B into two color sections each of which is equipped with an internal tungsten filament 34A, 34B. The upper tungsten filament 34A is very close to the top face 35A of the bulb so that the light emitting effect of the present invention will be even more idealistic. Also, in order to enhance the stability of connection of the upper and lower tungsten filaments 34A, 34B, the tungsten filaments are connected with inner sections of the conductive wires 32A, 33A. Preferably, the conductive wires above the upper tungsten filament and the conductive wires between the tungsten filaments 34A, 34B are formed with arched sections 32B, 33B which is as close to the inner wall face of the glass main body as possible. Therefore, the stability of the connection of the tungsten filaments with the conductive wires is enhanced.

The above embodiments are only used to illustrate the present invention, not intended to limit the scope thereof. Many modifications of the above embodiments can be made without departing from the spirit of the present invention.

What is claimed is:

1. Mini-type decorative bulb capable of emitting light through entire circumferential face, comprising a main body made of blank glass tube, a bead being disposed in the main body for locating two conductive wires, the conductive wires partially extending out of the main body for connecting with a power source, internal sections of the conductive wires extending into the main body for connecting with at least one tungsten filament, when a wick composed of the bead, the conductive wires and the tungsten filament is magnetically attracted and located in the main body, a previously clamped and sealed top end of the glass main body being blown and rounded to form a dome face through which light can pass, the other end of the main body being clamped and closed.

2. Mini-type decorative bulb capable of emitting light through entire circumferential face as claimed in claim 1, wherein the other end of the main body opposite to the dome face is clamped and closed to form a flat end which can be easily assembled with a bulb seat.

3. Mini-type decorative bulb capable of emitting light through entire circumferential face as claimed in claim 1, wherein two tungsten filaments are connected with inner sections of the conductive wires and positioned in different color sections, the conductive wires above the upper tungsten filament and the conductive wires between the tungsten filaments being formed with arched sections.
